(19) United States
(12) Patent Application Publication
(10) Pub. No.: US 2020/0143687 A1
(43) Pub. Date: May 7, 2020

(54) OPERATION MANAGEMENT APPARATUS AND OPERATION MANAGEMENT METHOD

(71) Applicant: TOYOTA JIDOSHA KABUSHIKI KAISHA, Toyota-shi (JP)

(72) Inventors: Kazuya WATANABE, Toyohashi-shi (JP); Koichi MORITA, Toyota-shi (JP); Tomohiro HASHIGUCHI, Shinagawa-ku (JP)

(73) Assignee: TOYOTA JIDOSHA KABUSHIKI KAISHA, Toyota-shi (JP)

(21) Appl. No.: 16/668,053

(22) Filed: Oct. 30, 2019

(30) Foreign Application Priority Data
Nov. 6, 2018 (JP) 2018-208961

(51) Int. Cl. G08G 1/00

(52) U.S. Cl. CPC G08G 1/20

(57) ABSTRACT

An operation management apparatus: is communicable with an information communication apparatus associated with a bus; determines, when receiving departure information of the bus during a stop in a transportation mall in which a platform place for the bus is provided from the information communication apparatus that is associated with the bus, assignment information including the platform place that a bus is supplemented to and a destination of the bus based on the departure information and predefined operation information; and transmits the determined assignment information to the information communication apparatus that is associated with the bus scheduled to be supplemented.

### INCORPORATION BY REFERENCE

The disclosure of Japanese Patent Application No. 2018-208961 filed on Nov. 6, 2018 including the specification, drawings and abstract is incorporated herein by reference in its entirety.

### BACKGROUND OF THE INVENTION

### 1. Field of the Invention

The present invention relates to an operation management apparatus and an operation management method.

### 2. Description of Related Art

Japanese Patent Application Publication No. 2007-264876 discloses a bus management system which creates an assignment plan such that a plurality of buses parked in a yard can leave the yard in turn based on identification numbers, the identification numbers given to the buses in an order in which the buses can smoothly leave the yard.

### SUMMARY OF THE INVENTION

With the system disclosed in JP 2007-264876 A, the buses are sequentially supplemented from the yard to a transportation mall where passengers get on, and each of the buses allows passengers to get on in the transportation mall and departs to a destination to/from which passengers are sent/picked up, on the basis of the assignment plan created in advance. However, with the system disclosed in JP 2007-264876 A, even when a previous bus cannot depart due to some trouble in the transportation mall, the buses are to be supplemented from the yard to the transportation mall on the basis of the assignment plan. Accordingly, there has arose a concern that such a plurality of buses stagnate in a limited space in the transportation mall, which situation causes a further delay or the like.

The present invention is devised in view of the aforementioned problem and has an object of providing an operation management apparatus and an operation management method capable of efficiently operating a plurality of movable bodies (buses) without causing the movable bodies to stagnate in a transportation mall.

In order to solve the aforementioned problem and achieve the object, there is provided an operation management apparatus according to the present invention, including: a memory; and a processor having hardware, wherein the processor: is communicable with an information communication apparatus associated with a movable body; determines, when receiving departure information of a movable body stopped in a transportation mall in which a platform for the movable body is provided from the information communication apparatus that is associated with the movable body, assignment information including a platform place that a movable body is supplemented to and a destination of the movable body based on the departure information and predefined operation information; and transmits the determined assignment information to the information communication apparatus that is associated with the movable body scheduled to be supplemented.

Moreover, in the operation management apparatus according to the present invention, a standby lane may be provided on the upstream side of the transportation mall, and the movable body scheduled to be supplemented may be a movable body standing by in the front row of the standby lane.

According to this, the movable body standing by in the front row of the standby lane is supplemented to the transportation mall so as to meet timing when a movable body departs from the transportation mall. Further, at the time of supplementation, the destination of the supplemented movable body is to be reported to a driver through the information communication apparatus. Therefore, even a situation where some trouble occurs on a previous movable body in the transportation mall can be flexibly handled, and the number of spare movable bodies in handling abnormality can be reduced. Moreover, since it is always a movable body standing by in the front row of the standby lane that is supplemented to the transportation mall, a space for the standby lane can be minimized (for example, just one line only has to be provided for the standby lane, etc.).

Moreover, in the operation management apparatus according to the present invention, a standby lane may be provided on the upstream side of the transportation mall, and a parking place may be on the upstream side of the standby lane, and the movable body scheduled to be supplemented may be a movable body parked in the parking place.

According to this, the movable body parked in the parking place is supplemented to the transportation mall so as to meet timing when a movable body departs from the transportation mall. Further, at the time of supplementation, the destination of the supplemented movable body is to be reported to a driver through the information communication apparatus. Therefore, since the driver can come to know the destination of the movable body in an earlier stage than ever, the driver can prepare a route in advance.

Moreover, in the operation management apparatus according to the present invention, the processor may determine the destination of the movable body included in the assignment information in accordance with a type of the movable body or driving performance of a driver of the movable body.

According to this, even when there are a plurality of types of movable bodies or there are differences in driving performance of individual drivers, a destination in accordance with the type of the movable body or the performance of the driver can be assigned.

In order to solve the aforementioned problem and achieve the object, there is provided an operation management method according to the present invention, the operation management method performed by an operation management apparatus, wherein a processor communicable with an information communication apparatus associated with a movable body: determines, when receiving departure information of a movable body during a stop in a transportation mall in which a platform for the movable body is provided from the information communication apparatus that is associated with the movable body, assignment information including a platform place that a movable body is supplemented to and a destination of the movable body based on the departure information and predefined operation information; and transmits the determined assignment information to the information communication apparatus that is associated with the movable body scheduled to be supplemented.

According to the present invention, since a movable body is not to be supplemented into the transportation mall when a movable body in the transportation mall does not depart as planned, stagnation of movable bodies in the transportation mall hardly occurs. Therefore, according to the present invention, a plurality of movable bodies can be efficiently operated.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing an operation management system to which an operation management apparatus according to an embodiment of the present invention can be applied;

FIG. 2 is a block diagram schematically showing a configuration of an operation management apparatus according to an embodiment of the present invention;

FIG. 3 is a diagram exemplarily showing a situation where an operation management apparatus according to an embodiment of the present invention performs operation management;

FIG. 4 is a flowchart showing a processing procedure of an operation management method performed by an operation management apparatus according to an embodiment of the present invention;

FIG. 5 is a diagram exemplarily showing a case where assignment information of a bus is linked in a transportation mall in an operation management method performed by an operation management apparatus according to an embodiment of the present invention;

FIG. 6 is a diagram exemplarily showing a case where assignment information of a bus is linked in a transportation mall in an operation management method performed by an operation management apparatus according to an embodiment of the present invention;

FIG. 7 is a diagram exemplarily showing a case where assignment information of a bus is linked in a depot in an operation management method performed by an operation management apparatus according to an embodiment of the present invention;

FIG. 8 is a diagram exemplarily showing a case where assignment information of a bus is linked in a depot in an operation management method performed by an operation management apparatus according to an embodiment of the present invention;

FIG. 9 is a diagram exemplarily showing an operation management method performed by a conventional operation management apparatus; and

FIG. 10 is a diagram exemplarily showing an operation management method performed by a conventional operation management apparatus.

### DETAILED DESCRIPTION OF EMBODIMENTS

An operation management apparatus and an operation management method according to an embodiment are described with reference to the drawings. Notably, constituents in the following embodiments include ones which persons skilled in the art can easily replace or are substantially equivalent.

Operation Management System

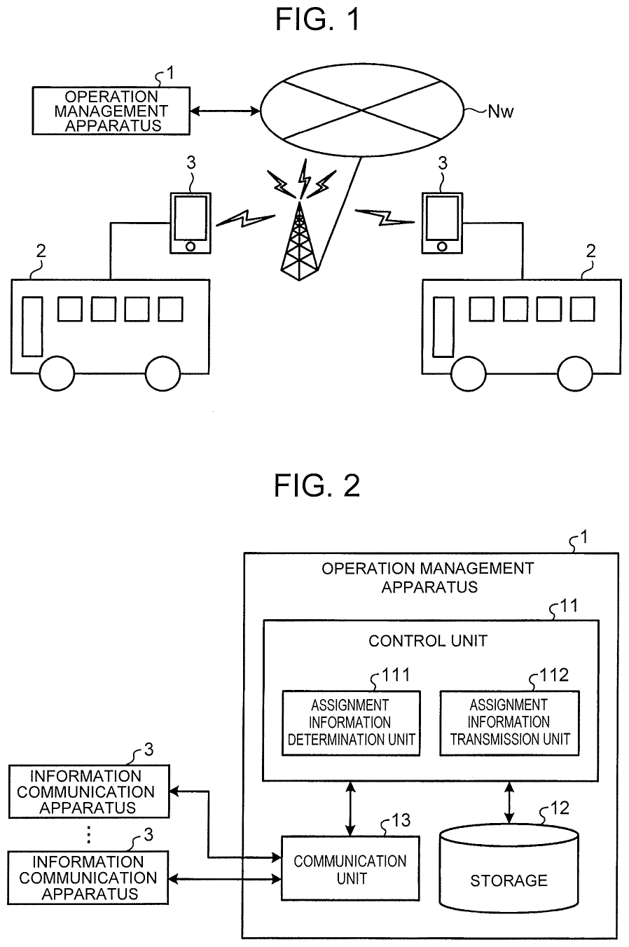

First, an operation management system to which the operation management apparatus according to the present embodiment can be applied is described with reference to FIG. 1. The operation management system is constituted of an operation management apparatus 1 and a plurality of buses 2 which are movable bodies associated with information communication apparatuses 3. The operation management apparatus 1 and the information communication apparatuses 3 associated with the plurality of buses 2 can communicate with each other through a network Nw.

The network Nw is constituted, for example, of any of an Internet network, a mobile phone network and the like. The information communication apparatus 3 is, for example, a smartphone, a tablet PC with a communication function, or the like which is held by a driver of the bus 2. In the bus 2, the information communication apparatus 3 is placed at a position (for example, close to driver's seat) where the driver can always recognize the contents of presentation on the information communication apparatus 3 (for example, any of a display screen, a speech sound and the like). As above, the operation management system provides a state where the driver of the bus 2 can always recognize the contents of presentation on the information communication apparatus 3, and in this sense, the information communication apparatus 3 and the bus 2 are associated with each other. Notably, the information communication apparatus 3 can also be realized, for example, by an in-vehicle navigation system with a communication function which system is mounted on the bus 2.

Operation Management Apparatus

Subsequently, a configuration of the operation management apparatus 1 according to the present embodiment is described with reference to FIG. 2. The operation management apparatus 1 includes a control unit 11, a storage 12 and a communication unit 13.

Specifically, the control unit 11 includes a processor composed of any of a central processing unit (CPU), a digital signal processor (DSP), a field-programmable gate array (FPGA) and the like, and a memory (main storage) composed of any of a random access memory (RAM), a read-only memory (ROM) and the like (none of these are shown in the figure).

The control unit 11 is configured to be communicable with the plurality of information communication apparatuses 3 associated with the buses 2 through the communication unit 13. Moreover, the control unit 11 loads a program stored in the storage 12 into a working area of the main storage to execute the program, and realizes functions which meet predetermined purposes by controlling individual components and the like through the execution of the program. The control unit 11 functions as an assignment information determination unit 111 and an assignment information transmission unit 112 through the aforementioned execution of the program. Notably, details of the individual units are mentioned later.

The storage 12 is constituted of a recording medium such as an erasable programmable ROM (EPROM), a hard disk drive (HDD) or a removable medium. Examples of the removable medium include a universal serial bus (USB) memory, and disc recording media such as a compact disc (CD), a digital versatile disc (DVD) and a Blu-ray® disc (BD). Moreover, there can be stored in the storage 12 an operating system (OS), various programs, various tables, various databases and the like.

The communication unit 13 is constituted, for example, of any of a local area network (LAN) interface board, a wireless communication circuit for wireless communication, and the like. The communication unit 13 is connected to the network Nw such as the Internet which is a public communication network. Further, the communication unit 13 is connected to the relevant network Nw to perform communication with the information communication apparatuses 3.

Operation Management Method

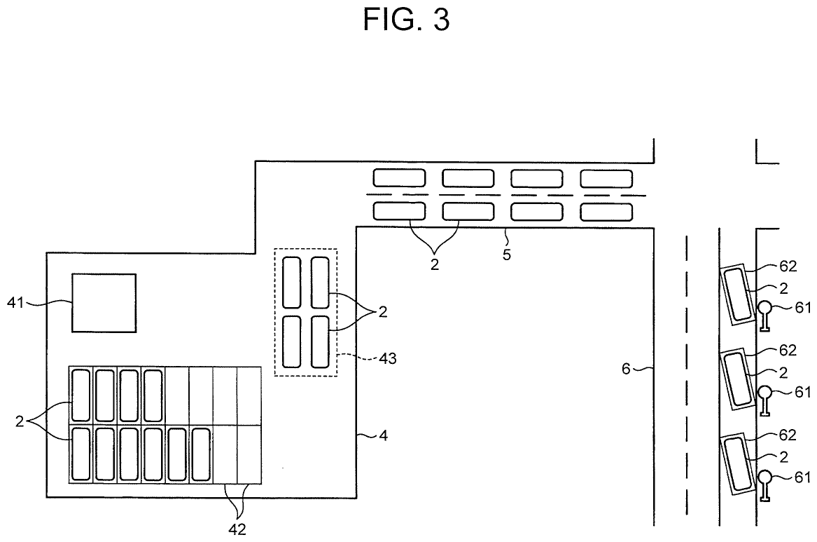

Subsequently, an operation management method performed by the operation management apparatus 1 is described with reference to FIG. 3 to FIG. 8. As shown in FIG. 3, the operation management apparatus 1 performs operation management of the plurality of buses 2 in a depot (parking place) 4, in a mall standby lane (standby lane) 5 and in a transportation mall 6. Notably, the mall standby lane 5 is positioned on an upstream side of the transportation mall 6. Moreover, the depot 4 is positioned on an upstream side of the mall standby lane 5.

The depot 4 is a parking place (yard) for parking and keeping the buses 2. The depot 4 is provided with an office 41, a parking area 42 and a depot standby lane 43. The office 41 is a place for allowing a driver before boarding the bus 2 to stand by, that is, for allowing a driver of the bus 2 to be driven by which has not been determined yet (to which the bus 2 has not been linked yet) to stand by. In the office 41, it is determined which driver is caused to board a bus 2 in the depot 4 (specifically, in the parking area 42) based on a predefined work table or the like, and the bus 2 and the driver are linked to (associated with) each other.

When the aforementioned information communication apparatus 3 is herein a smartphone, a tablet PC with a communication function, or the like which is portable, the information communication apparatus 3 is lent to the driver to which the bus 2 has been already linked, for example, in the office 41. Then, the driver takes the lent information communication apparatus 3 and boards the bus 2 to send and receive information to/from the operation management apparatus 1 through the information communication apparatus 3 during boarding the bus 2.

The parking area 42 is a place for parking the plurality of buses 2 that are before being operated. Moreover, the depot standby lane 43 is a place for allowing the buses 2 that are after determined to be operated, that is, that have been already linked to the drivers to temporarily stand by. The buses 2 stand by in the depot standby lane 43 until each of them receives assignment information from the operation management apparatus 1 through the information communication apparatus 3.

The mall standby lane 5 is a place where the buses 2 that are before supplemented to the transportation mall 6 positioned on a downstream side of the mall standby lane 5 temporarily stand by. The buses 2 stand by in the mall standby lane 5 until each of them receives assignment information from the operation management apparatus 1 through the information communication apparatus 3.

The transportation mall 6 is a place where passengers get on and get off the buses 2. The transportation mall 6 is provided with platforms 61 for the passengers who get on and get off, and standby areas 62 for the buses 2 standing by.

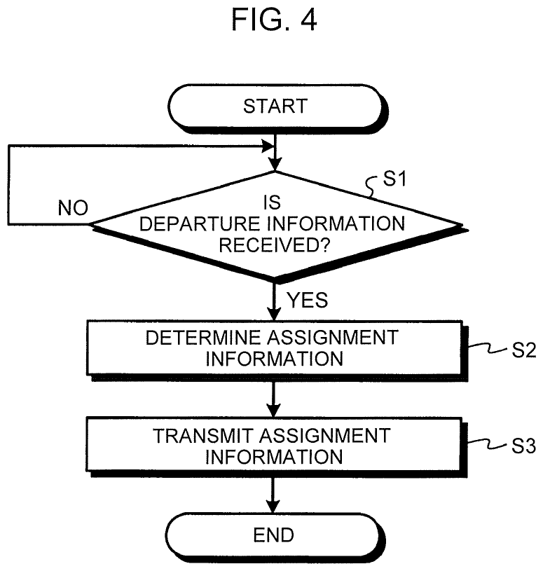

Hereafter, a specific processing procedure of the operation management method performed by the operation management apparatus 1 is described with reference to FIG. 4 to FIG. 8. First, the assignment information determination unit 111 determines whether or not departure information of a bus 2 during a stop in the transportation mall 6 is received from the information communication apparatus 3 that is associated with the relevant bus 2 (step S1).

Herein, the aforementioned “departure information of a bus 2” is information that the bus 2 has departed for a predetermined destination (to/from which passengers are sent/picked up) from the transportation mall 6. For example, the departure information is manually transmitted by the driver of the bus 2 which departs from the transportation mall 6 through the information communication apparatus 3 held by that driver. Notably, the departure information may also be transmitted not only by the driver of the bus 2 which departs but also through the information communication apparatus 3 that is arranged, for example, close to the platform 61 and held by a dispatcher (starter).

When it is determined that in step S1, the departure information of the bus 2 during the stop in the transportation mall 6 is received from the information communication apparatus 3 that is associated with the relevant bus 2 (Yes in step S1), the assignment information determination unit 111 determines assignment information based on the departure information and predefined operation information (step S2). On the other hand, when it is determined that in step S1, the departure information of the bus 2 during the stop in the transportation mall 6 is not received from the information communication apparatus 3 that is associated with the relevant bus 2 (No in step S1), determination in step S1 is repeated.

Herein, the aforementioned “assignment information” includes information regarding a destination to which a bus 2 is supplemented, and information regarding a destination of the bus 2. Moreover, the “information regarding a destination to which a bus 2 is supplemented” is information regarding which place (platform 61, standby area 62) in the transportation mall 6 a bus 2 scheduled to be supplemented is supplemented to, and is determined based on the aforementioned departure information of a bus 2. Moreover, the “information regarding a destination of a bus 2” is information regarding where to transport passengers who get on in the transportation mall 6, and is determined based on the aforementioned operation information.

Notably, the assignment information determination unit 111 may determine the destination of the bus 2, included in the assignment information in accordance with a type of the bus 2 (hereinafter referred to as “bus type”) such as the size of the bus 2 or driving performance of a driver of the bus 2. Thereby, even when there are a plurality of bus types or there are differences in driving performance of individual drivers, a destination in accordance with a bus type or performance of a driver can be assigned.

Subsequently, the assignment information transmission unit 112 transmits the assignment information determined by the assignment information determination unit 111 to the information communication apparatus 3 that is associated with the bus 2 scheduled to be supplemented (step S3). The processing of the operation management method performed by the operation management apparatus 1 is thus completed.

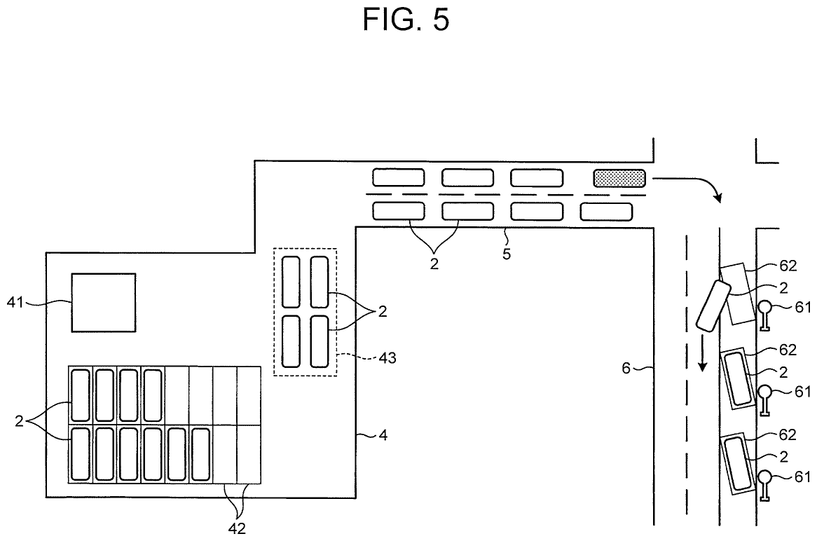

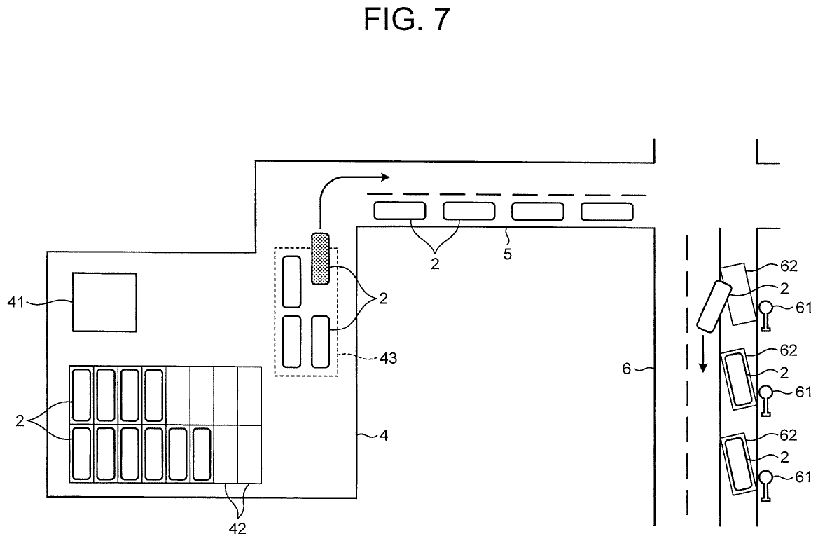

Herein, as the aforementioned “bus 2 scheduled to be supplemented” in step S3, there can be considered any of the following two: (1) a bus 2 standing by in the front row of the mall standby lane 5 (the bus 2 dotted in FIG. 5); and (2) a bus 2 parked in the parking area 42 of the depot 4 (the bus 2 dotted in FIG. 7).

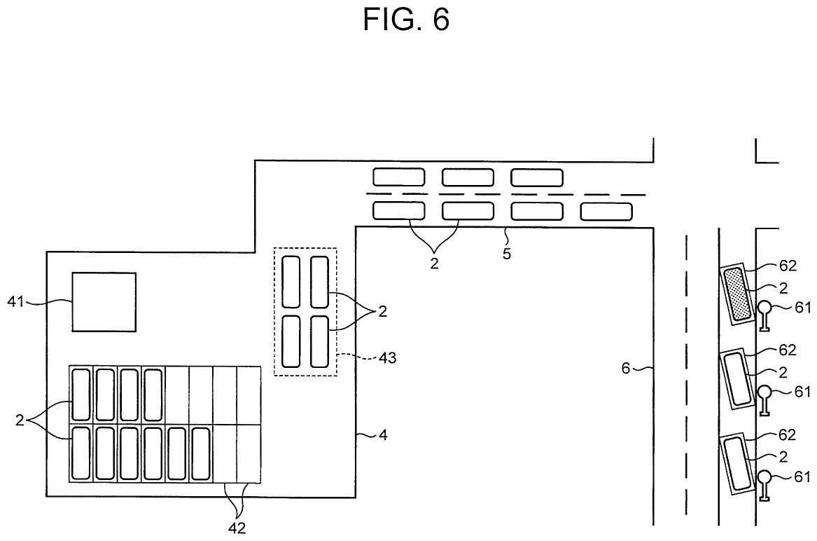

When the “bus 2 scheduled to be supplemented” is (1) above, the assignment information transmission unit 112 transmits the assignment information determined by the assignment information determination unit 111 to the information communication apparatus 3 that is associated with the bus 2 standing by in the front row of the mall standby lane 5 (bus 2 dotted in FIG. 5). Thereby, as shown in FIG. 5 and FIG. 6, the bus 2 standing by in the front row of the mall standby lane 5 is supplemented to the transportation mall 6 so as to meet timing when a bus 2 departs from the transportation mall 6. Further, at the time of supplementation, the destination of the supplemented bus 2 is to be reported to the driver through the information communication apparatus 3.

As above, when the “bus 2 scheduled to be supplemented” is (1) above, even a situation where some trouble occurs on a previous bus 2 in the transportation mall 6 can be flexibly handled, and the number of spare buses 2 in handling abnormality can be reduced. Moreover, since it is always a bus 2 standing by in the front row of the mall standby lane 5 that is supplemented to the transportation mall 6, a space for the mall standby lane 5 can be minimized (for example, just one line only has to be provided for the standby lane).

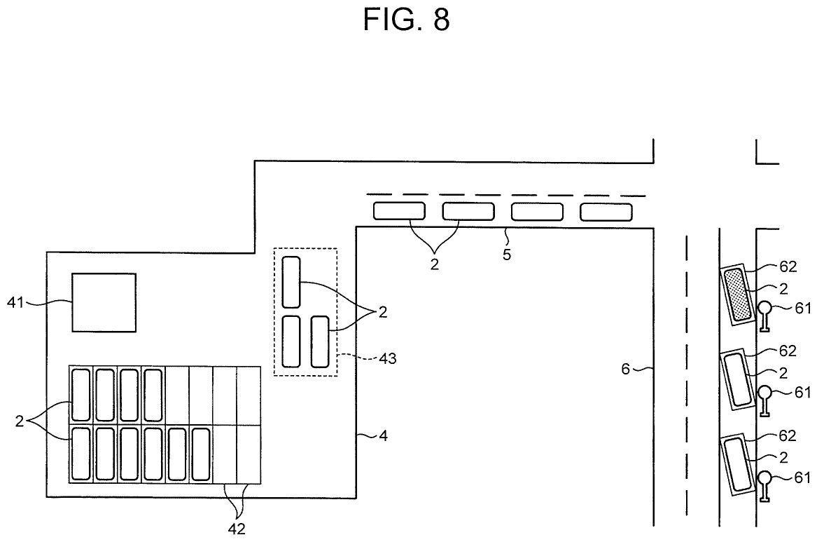

On the other hand, when the “bus 2 scheduled to be supplemented” is (2) above, the assignment information transmission unit 112 transmits the assignment information determined by the assignment information determination unit 111 to the information communication apparatus 3 that is associated with the bus 2 standing by in the depot standby lane 43 of the depot 4 (bus 2 dotted in FIG. 7). Thereby, as shown in FIG. 7 and FIG. 8, the bus 2 standing by in the depot standby lane 43 of the depot 4 is supplemented to the transportation mall 6 so as to meet timing when a bus 2 departs from the transportation mall 6. Further, at the time of supplementation, the destination of the supplemented bus 2 is to be reported to the driver through the information communication apparatus 3.

As above, when the “bus 2 scheduled to be supplemented” is (2) above, the driver can come to know the destination of the bus 2 in an earlier stage than ever. Accordingly, the drive can sufficiently prepare a route in advance.

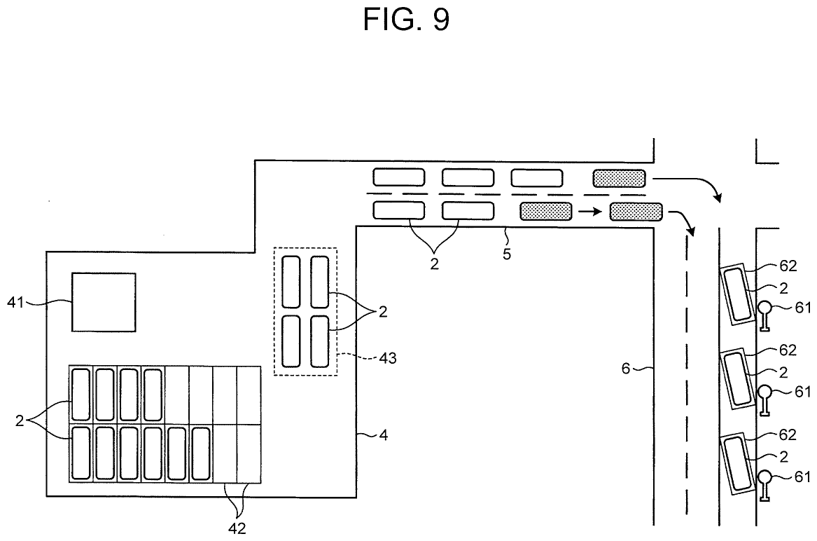

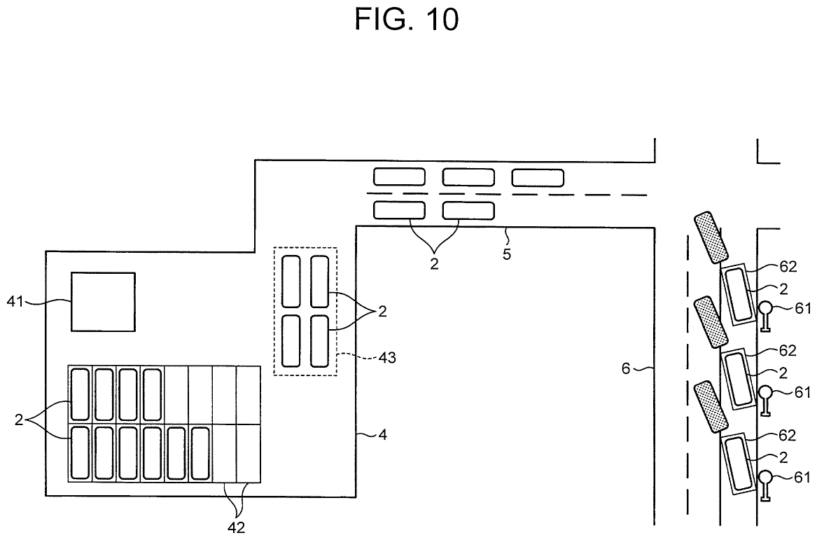

Now, as shown in FIG. 9, in an operation management method performed by a conventional operation management apparatus, even when a previous bus 2 cannot depart from the transportation mall 6 due to some trouble, an assignment plan created in advance has been strictly kept, so that buses 2 have been supplemented to the transportation mall 6 based on the assignment plan. Accordingly, as shown in FIG. 10, such an operation management method performed by the conventional operation management apparatus has caused a concern that a plurality of buses 2 stagnate in a limited space in the transportation mall 6, which situation causes a further delay or the like.

On the other hand, in the operation management method performed by the operation management apparatus 1 according to an embodiment, a predefined assignment plan is used simply as a guide. Since a bus 2 is not to be supplemented into the transportation mall 6 if buses 2 in the transportation mall 6 do not depart as planned, stagnation of buses 2 in the transportation mall 6 hardly occurs. Therefore, according to the operation management method performed by the operation management apparatus 1 according to an embodiment, a plurality of buses 2 can be efficiently operated.

As above, an operation management apparatus and an operation management method according to the present invention have been specifically described with some modes for implementing the present invention. The scope and spirit of the present invention are not limited to the aforementioned description of the operation management apparatus and the operation management method but should be broadly interpreted based on the description of the appended claims. Moreover, it is needless to say that the scope and spirit of the present invention should include various changes, alterations and the like based on the aforementioned description of the operation management apparatus and the operation management method.

Additional advantages and modifications can readily occur to persons skilled in the art. Therefore, the invention in its broader aspects is not limited to the specific detailed and representative embodiments presented and described as above. Accordingly, various changes, alterations and modifications may occur without departing from the scope or spirit of the general inventive concept as defined by the appended claims and their equivalents.

What is claimed is:

1. An operation management apparatus comprising:
a memory; and
a processor having hardware, wherein the processor:
is communicable with an information communication apparatus associated with a movable body;
determines, when receiving departure information of the movable body during a stop in a transportation mall in which a platform for the movable body is provided from the information communication apparatus that is associated with the movable body, assignment information including a platform place that a movable body is supplemented to and a destination of the movable body based on the departure information and predefined operation information; and
transmits the determined assignment information to the information communication apparatus that is associated with the movable body scheduled to be supplemented.

2. The operation management apparatus according to claim 1, wherein:
a standby lane is provided on an upstream side of the transportation mall; and
the movable body scheduled to be supplemented is a movable body standing by in a front row of the standby lane.

3. The operation management apparatus according to claim 1, wherein:
a standby lane is provided on an upstream side of the transportation mall, and a parking place is provided on an upstream side of the standby lane; and
the movable body scheduled to be supplemented is a movable body parked in the parking place.

4. The operation management apparatus according to claim 1, wherein the processor determines the destination of the movable body included in the assignment information in accordance with a type of the movable body or driving performance of a driver of the movable body.

5. An operation management method performed by an operation management apparatus, wherein a processor communicable with an information communication apparatus associated with a movable body:
determines, when receiving departure information of a movable body during a stop in a transportation mall in which a platform for the movable body is provided from the information communication apparatus that is associated with the movable body, assignment information including a platform place that a movable body is supplemented to and a destination of the movable body based on the departure information and predefined operation information; and
transmits the determined assignment information to the information communication apparatus that is associated with the movable body scheduled to be supplemented.
